(19) United States
(12) Patent Application Publication
(10) Pub. No.: US 2018/0030747 A1
(43) Pub. Date: Feb. 1, 2018

(54) Protector Unit For A Sliding Door Frame

(71) Applicant: Rodney Kim Ferris, Naples, FL (US)

(72) Inventor: Rodney Kim Ferris, Naples, FL (US)

(21) Appl. No.: 15/224,761

(22) Filed: Aug. 1, 2016

(51) Int. Cl. E04G 21/30; E06B 1/52; E06B 3/46; E06B 1/70

(52) U.S. Cl. CPC E04G 21/30; E06B 1/70; E06B 1/52; E06B 3/4636

(57) ABSTRACT

A protector for a sliding door frame includes an inverted U-shaped sill riser cover and a sill plate cover and means for snapping the two covers together to form a rigid unitary unit for protecting the sliding door frame during construction.

### CROSS REFERENCE TO RELATED APPLICATIONS

Not applicable

### STATEMENT REGARDING FEDERALLY SPONSORED RESEARCH OR DEVELOPMENT

Not applicable

### NAMES OF THE PARTIES TO JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

Not applicable

### SEQUENCE LISTING

Not applicable

### BACKGROUND OF THE INVENTION

### Field of the Invention

The present invention relates to a protective cover unit for sliding door frame used in commercial and residential entryways to be used during construction or renovation.

### Background

Entryways in commercial and residential buildings serve several important purposes in their role as a transition from the exterior to the interior of the building. The primary goal of an entryway is to allow for ingress and egress while insulating the Interior from the exterior. Entryways are intended to prevent intrusion of rainwater, the passage of air, transfer of heat and can enhance the appearance of the building. Once the building is “under roof” the windows and doors are installed in order to protect the interior thereof from the environment. This leaves the sliding door frame exposed to any damage from workers that remains within the building. Heavy traffic of workers entering the building, including the movement of equipment and materials, can often lead to severe damage to the sliding door frame.

Protective covers have been disclosed that are designed to temporarily remain on the sliding door frame during construction. Some have hinges which fasten to the door frame, others are blankets which cover the frame and others are metallic rigid ramps which overlie the door frame. The present invention provides a unique protector unit for the sliding door frame because of its two piece construction with means for rigidly connecting them together on the job site which is an improvement in the prior art.

### SUMMARY OF THE INVENTION

The following presents a simplified summary of the invention in order to provide a basic understanding of the many aspects of the invention.

The present invention is concerned with protecting the frame of a sliding door during construction.

The primary object of the present invention is to provide a two piece protector for the base frame of the sliding door frame.

A further object of the present invention is to provide an inverted U-shaped element which is capable of covering the sill riser.

A further object of the present invention is to provide a flat flexible sill plate cover with sufficient width and length to cover the sill plate.

A further object of the invention is to provide means for connecting the sill riser cover with the sill plate cover to create a rigid unitary protector unit.

A further object of the present invention is to provide scoring marks on the sill riser cover.

A further object of the present invention is to provide a plurality of channel members protruding from the lower surface of the sill plate cover to give stability thereto.

A further object of the present invention is to provide an additional segment to abut edge to edge with the sill plate cover to give additional depth.

Another object of the present invention is to provide a protector for the sliding door frame having a vertical jamb component.

Another object of the present invention is to provide a protector for the sliding door edge.

These and other aspects of the present invention will become more apparent to those having ordinary skill in the art after reading the following description of the preferred embodiments of the present invention, when considered in conjunction with the accompanying formal drawings wherein the same reference numerals are used consistently throughout the many drawing figures. It should be understood that variations may be made in details and general features of the design without departing from the spirit and scope of the invention. In addition it is pointed out that the sill plate cover of the present invention is dimensioned such that it could be used to protect the vertical door jamb because the structure of the jamb would be similar as the sill plate. It could easily be screwed into the jamb and provide protection thereof. Likewise the sill riser cover could also be used to cover the edge of the sliding door.

### BRIEF DESCRIPTION OF THE DRAWINGS

FIG. 1 is an exploded view of sliding door frame with the protector unit of the present invention.

FIG. 2 is a detailed view of the connection means of the present invention.

FIG. 3 is a detailed view of another embodiment of the connection means.

FIG. 4 is a detailed view of still another embodiment of the connection means.

FIG. 5 is a detailed view of an additional segment connected to the sill plate cover.

### DETAILED DESCRIPTION OF THE DRAWINGS

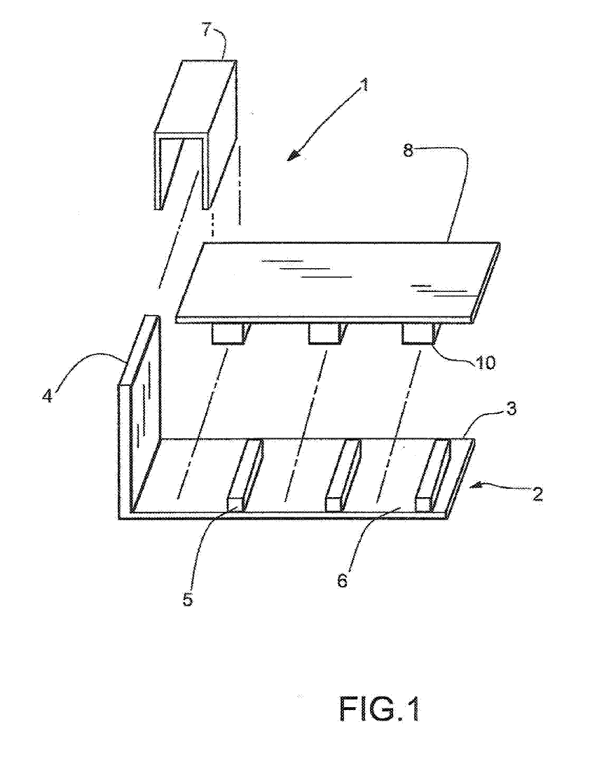

FIG. 1 is a detailed exploded view of the preferred embodiment of the present invention which includes a protector unit 1 for a sliding door frame 2. The sliding door frame 2 consists of a sill plate 3 and a sill riser 4. The sill plate 3 is attached to the door entryway and has a plurality of tracks 5 for supporting the rollers at the base of the sliding doors. The number of tracks 5 would be equal to the number of sliding doors plus screen doors for a particular building arrangement. A channel space 6 is provided on either side of the tracks 5 for passage of the sliding doors. For example, if there were three sliding doors then there would be three tracks and four channel spaces. This is well known in the construction trades and is not considered part of the present invention. The sill riser 4 abuts the sill plate 3 and extends parallel thereto. The height of the sill riser 4 is driven by the design pressure measured in pounds per square foot of wind pressure on the sliding door assembly. During construction of a building the sliding door frame 2 is installed between the supporting walls of a building. The sliding door frame 2 is exposed to damage by the mere moving of equipment in and out of the building through the entryway. The protector unit 1 of the present invention provides for a sill riser cover 7 and a sill plate cover 8 which are fastened together by connection means 9. The sill riser cover 7 is shown as an modified inverted U-shaped flexible member made of a rubberized plastic, cardboard or vinyl material which can be either molded or extruded and can be about ⅛^{th} of an inch thick. The sill plate cover 8 is flat planar flexible member having an upper surface 8a and a lower surface 8b which extends horizontally over the sill plate 3 and can be made of a rubberized plastic, cardboard or vinyl material which can be either molded or extruded and can be about % of an inch thick. A plurality of channel members 10 extend from said lower surface 8b of the sill plate cover 8 and are seated within the channel spaces 6 between the tracks 5 which give stability to the sill plate cover 8.

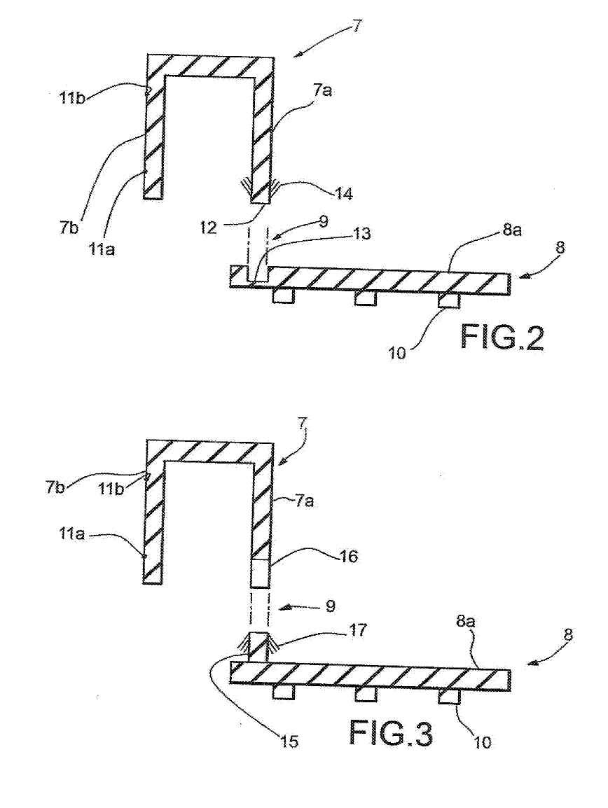

FIG. 2 is a sectional view of the connection means 9 showing the detail of the sill riser cover 7 having a first leg 7a and a second leg 7b with the first leg 7a having an extension edge 12 capable of mating with a slot 13 on the upper surface 8a of the sill plate cover 8. The extension edge 12 has a plurality of splines 14 positioned thereon to insure a rigid snap fit into the slot 13. The second leg 7b has a plurality of score marks 11a and 11b positioned vertically thereon which can be easily cut when the carpet pad, carpet, wood flooring are laid. For example, once the carpet and carpet pad were installed, the sill riser cover 7 would be cut at score mark 11a. If wood flooring was laid then the sill riser cover 7 would be cut at score mark 11b.

FIG. 3 is a sectional view of the connection means 9 showing the detail of the sill riser cover 7 having a first leg 7a and a second leg 7b and wherein the first leg 7a having a recess 16 which can easily mate with a finger 15 extending upwardly from the upper surface 8a of sill plate cover 8. The finger 15 can have a plurality of splines 17 thereon to insure a rigid snap fit into the recess 16 within the sill riser cover 7. For example, once the carpet and carpet pad were installed, the sill riser cover 7 would be cut at score mark 11a. If wood flooring was laid then the sill riser cover 7 would be cut at score mark 11b.

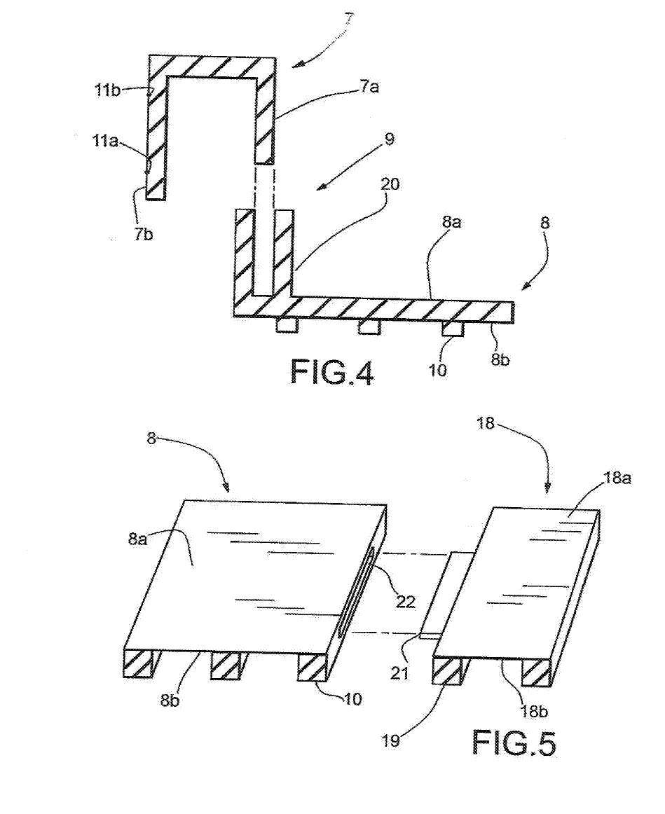

FIG. 4 is a sectional view of the connection means 9 including the sill riser cover 7 having a first leg 7a and a second leg 7b. The first leg 7a is inserted into the vertical groove 20 and a second leg 7b positioned on the “room side” of the sill riser 4. For example, once the carpet and carpet pad were installed, the sill riser cover 7 would be cut at score mark 11a. If wood flooring was laid then the sill riser cover 7 would be cut at score mark 11b.

FIG. 5 is a sectional view of the sill plate cover 8 having a plurality of channel members 10 extending from the lower surface 8b thereof. An additional segment 18 is provided with additional channel members 19 extending from the lower surface 18b and having a protuberance 21 capable of mating with opening 22 on the channel member 10. It is contemplated that this design could take on many different alternatives; for example, the opening 22 on channel member 10 could run the entire length thereof with the protuberance 21 running the entire length of the additional channel member 19. Openings 22 could be designed as a plurality of openings spaced along the channel member 10. Of course the protuberance 21 would be designed accordingly to mate the channel member 10 with the additional channel member 19. As another alternative, the protuberance 21 could extend from the channel member 10 with the openings 22 formed in the additional channel member 19.

1: A protector unit for a sliding door frame having a sill plate and a sill riser comprising: a sill plate cover having an upper surface and a lower surface and a sill riser cover, a first connection element positioned on said upper surface of said sill plate cover and a second connection element positioned on said sill riser cover such that when the first connection element is mated with the second connection element a rigid unitary protector unit is formed to protect the sliding door frame.

2: The protector unit of claim 1, wherein said first connection element positioned on the upper surface of said sill plate cover is a slot and said second connection element positioned on the sill riser cover is an extension edge such that upon mating the extension edge of the sill riser cover is seated in said slot in the sill plate cover.

3: The protector unit of claim 1, wherein the first connection element positioned on the upper surface of the silt plate cover is a finger and the second connection element on the sill riser cover is a recess therein.

4: The protector unit of claim 1, wherein the sill riser cover is an inverted U-shaped flexible member having a first leg and a second leg, said first connection element positioned on said sill plate cover is a vertical grove extending from the upper surface thereof and said second connection element of the sill riser cover is the first leg of the sill riser cover wherein the second leg slides into the vertical groove on the sill plate cover.

5: The protector unit of claim 4, wherein scoring marks are provided on the second leg of said sill riser cover.

6: The protector unit of claim 2, wherein the said extension edge of the sill riser cover has a plurality of splines positioned thereon and when inserted into the slot on the upper surface of the sill plate cover the splines grab the sides of the slot to create a rigid snap fit.

7: The protector unit of claim 3, wherein the finger extending from the upper surface of the sill plate cover has a plurality of splines positioned thereon wherein the splines on the finger grab the sides of the recess to create a rigid snap fit.

8: The protector unit of claim 1, wherein the sill plate cover has a plurality of channel members extending from the lower surface thereof for stability when placed on the sill plate.

9: For use with a sliding door frame, said frame having a sill riser and a sill plate wherein said sill plate has a plurality of tracks for the travel of rollers positioned at the base of a sliding door and channel spaces positioned between the of tracks, the protector unit comprising: a flexible inverted U-shaped sill riser cover having a first leg having an extension edge and a second leg, a sill plate cover including a flat flexible member having an upper and lower surface and sized to cover the sill plate, a plurality of channel members extending from the lower surface thereof and designed to be seated within the channel spaces to give stability to the protector unit, a slot formed in the upper surface of the flat planar member such that when positioned on the sliding door frame the extension edge of the sill riser cover is snapped into the slot on the upper surface of the sill plate cover to from a unitary rigid protector unit.

10: The protector unit of claim 9, further comprising scoring marks are positioned on the second leg said sill riser cover for facilitating cutting thereof.

11: The protector unit of claim 9, further comprising an additional segment having an additional channel member positioned therebeneath and having a means extending therefrom for connecting the channel member on the sill plate riser to the additional channel member on the additional segment to increase the depth of said sill plate cover.

12: For use with a sliding door frame, said frame having a sill riser and a sill plate wherein said sill plate having a plurality of tracks for the travel of rollers positioned at the base of a sliding door and channel spaces positioned between the tracks, the protector unit comprising: a sill riser cover formed as a planar flexible U-shaped member and having a first leg and a second leg, said second leg having a recess therein, a sill plate cover including a flat flexible member having an upper and lower surface and sized to cover the sill plate, a plurality of channel members extending from the lower surface thereof and designed to be seated within the channel spaces, a rigid finger extending upwardly from the upper surface of the flat planar member such that when positioned on the sliding door frame said recess in said first leg of the sill riser cover snaps onto the finger on the upper surface of the sill plate cover to from a unitary rigid protector unit.

12: The protector unit of claim 11, further comprising a scoring marks on said second leg of said sill riser cover for facilitating cutting thereof.

13: The protector unit of claim 11, further comprising an additional segment having an additional channel member positioned therebeneath and having a means extending therefrom for connecting the channel member on the sill plate cover to the additional channel member on the additional segment to increase the breadth of said sill plate cover.
